(19) United States
(12) Patent Application Publication
(10) Pub. No.: US 2016/0052369 A1
(43) Pub. Date: Feb. 25, 2016

(54) DEVICE FOR AIR FLOW ADJUSTMENT

(71) Applicant: AUDI AG, Ingolstadt (DE)

(72) Inventors: MIKE HERBIG, Beilngries (DE); RICHARD PICKL, Denkendorf (DE)

(73) Assignee: AUDI AG, Ingolstadt (DE)

(21) Appl. No.: 14/829,329

(22) Filed: Aug. 18, 2015

(30) Foreign Application Priority Data
Aug. 19, 2014 (DE) 10 2014 012 248.4

(51) Int. Cl. B60H 1/34

(52) U.S. Cl. CPC B60H 1/3421; B60H 2001/3471

(57) ABSTRACT

A device for air flow adjustment, includes a base body having at least two closable or releasable passage openings, wherein the passage openings are arranged in a vehicle front area and are each coupled to a respective ventilation shaft; a first adjustment element configured as a linearly movable flap, wherein the first adjustment element is movable into a first position in which it closes the at least two passage openings, a second position in which it releases one of the at least two passage openings and closes another one of the at least two passage openings, and a third position in which it closes both of the at least two passage openings.

### CROSS-REFERENCES TO RELATED APPLICATIONS

This application claims the priority of German Patent Application, Serial No. 10 20014 012 248.4, filed Aug. 19, 2014, pursuant to 35 U.S.C. 119(a)-(d), the disclosure of which is incorporated herein by reference.

### BACKGROUND OF THE INVENTION

The present invention relates to a device for air flow adjustment.

The following discussion of related art is provided to assist the reader in understanding the advantages of the invention, and is not to be construed as an admission that this related art is prior art to this invention.

Devices for air flow adjustment are known in numerous variations. Usually, these devices include at least one passage opening, which is arranged at the vehicle front and is coupled with at least one corresponding ventilation shaft. Through the passage opening, an air flow generated by the vehicle air stream is channeled and directed and is, for example guided to a heat exchanger or a vehicle aggregate. The heat exchanger can be designed as air-coolant-heat exchanger for a drive unit and/or as oil cooler and/or as air-coolant-heat exchanger for an air conditioner. The air flow can thus cool a vehicle aggregate directly or via a corresponding heat exchanger. Entering of the air flow into the at least one passage opening arranged at the vehicle front can lead to a so-called “blocking”, which may increase the drag of the vehicle, which may lead to increased fuel consumption. Usually, the at least one passage opening can assume a closed and a released state. In the closed state, no cooling air flow can flow into the interior of the vehicle and the vehicle has a lower drag than in the released state, In the released state the cooling air flow may flow into the interior of the vehicle, however, the drag of the vehicle is increased. The passage opening can for example be released and closed by pivotal fins.

From DE 10 2009 058 284 A1, a vehicle front section is known, including at least one opening for passage of air flow therethrough, particularly as cooling air, for example for incident flow of an intercooler. The at least one passage opening is thereby at least partly coverable by a license plate of the vehicle and/or by a carrier of the license plate, wherein the vehicle's aerodynamics can be enhanced due to the covering of the at least one passage opening. For this purpose, the license plate is movable between a first position covering the opening and a second position releasing the opening.

From DE 10 2004 026 419 A1, a generic device is known for adjusting an air flow through passage openings provided in the front section. By changing passage cross sections of the passage openings, air flow towards the engine compartment can be adjusted. The described device includes at least two passage openings, a first upper passage opening and a second lower passage opening. The first passage opening is assigned to an upper air intake zone and is coupled to a first corresponding ventilation shaft. The second passage opening is assigned to an air intake zone arranged lower in vertical direction and is coupled to a second corresponding ventilation shaft. In order to adjust an air flow passing through the first ventilation shaft and to adjust an air flow passing through the second ventilation shaft, pivotal fins are arranged in the area of the first and second passage openings, which change the corresponding passage cross sections of the passage openings by taking into account the vehicle's operating state.

It would therefore be desirable and advantageous to provide an improved a device for air flow adjustment, which reliably satisfies aerodynamic and thermal requirements of a vehicle and is of simple design

### SUMMARY OF THE INVENTION

According to one aspect of the present invention, a device for air flow adjustment includes a base body having at least two closable or releasable passage openings, wherein the passage openings are arranged in a vehicle front area and are each coupled to a respective ventilation shaft; and a first adjustment element configured as a linearly movable flap, wherein the first adjustment element is movable into a first position in which it closes the at least two passage openings, a second position in which it releases one of the at least two passage openings and closes another one of the at least two passage openings, and a third position in which it closes both of the at least two passage openings

In order to provide a device for air flow adjustment, which reliably satisfies aerodynamic and thermal requirements of a vehicle and is of simple design, a first adjustment element is designed as linearly movable flap which, in a first position, closes at least two passage openings, in a second position releases a first passage opening and closes a second passage opening and, and in a third position releases both passage openings.

In the following, the term “aerodynamic requirements” means that the vehicle has a drag which is as low as possible. Because entering of a an air flow, which particularly results from the vehicle air stream, into the at least one passage opening arranged at a vehicle front, may lead to so-called ‘blocking’ and consequently increase drag, it is useful for aerodynamic reasons to close the passage openings.

In the following, the term “thermal requirements” is to be understood as the cooling of a passenger compartment and/or the cooling of at least one vehicle aggregate. With regard to a thermal considerations it is practicable to arrange as many passage openings as possible at the vehicle front and to release them.

Advantageously, the at least two passage openings of the device to adjust an air flow according to the invention can be released as needed, so that the thermal requirements can be met. Furthermore, the first adjustment element is advantageously designed as linearly movable flap so that the at least two passage openings can be arranged at a side area of the vehicle front. The at least two passage openings are each connected to a corresponding ventilation shaft. Advantageously, a first ventilation shaft, which is coupled to the first passage opening, can be coupled to a heat exchanger for an air conditioner for tempering the interior of the vehicle. The second passage opening can be coupled to a second ventilation shaft, which can for example be coupled to a heat exchanger for cooling the vehicle aggregate and/or can directly be coupled to a vehicle aggregate to be cooled. Advantageously, the device for air flow adjustment according to the invention may operate in stages and depending on the situation may supply only one ventilation shaft or multiple ventilation shafts with the cooling air flow. This allows optimizing an influx of cooling air. Advantageously, further passage openings and corresponding ventilation shafts can be provided, which are coupled to further heat exchangers or vehicle aggregates to be cooled. Hereby, the flap can be moved into further positions or in the second position can release two openings and close further openings. The functioning of the device can simply be tested by visual inspection because the sliding of the flap can be seen from outside.

According to another advantageous feature of the invention, the first adjustment element can be supported so as to be horizontally movable in transverse direction of the vehicle and the at least two passage openings can be arranged next to each other in transverse direction of the vehicle. Advantageously, the passage openings can be opened and released with a low drag due to the lateral movement.

According to another advantageous feature of the invention a second adjustment element is capable of forming a fin, when the first adjustment element is arranged in the second or third position. The fin can for example be formed by folding and/or bending of the second adjustment element. Advantageously, the fin can form an air flow guide, which can be activated when needed. The fin can advantageously replace a separate or fixed air baffle, by which further air friction can be at least partly prevented.

According to another advantageous feature of the invention, the base body can include at least one slotted guide, which guides the first adjustment element. In a preferred embodiment, the slotted guide can for example, extend at least partly behind the second adjustment element. A vehicle front hereby has a front section facing the air stream that acts on the vehicle and a rear section facing the vehicle interior. Advantageously, in second and third position the first adjustment element is at least partially arranged in the rear section and can be protected by the second adjustment element from external influences, The arrangement of the second adjustment element in the rear section also allows at least partly preventing the occurrence of further air friction effects resulting from the first adjustment element in the second and third position. In the first position, the first adjustment element can furthermore align on the outer surface of the vehicle front, so that air friction effects can at least be reduced in the first position.

According to another advantageous feature of the invention, the base body can include an receptacle for a drive. Hereby, the drive can be coupled to the first adjustment element and/or the second adjustment element. The power unit can for example be constructed as electric motor, which can be coupled to the first adjustment element and/or the second adjustment element via an adjustment element. Furthermore, the power unit can advantageously be connected to a processing- and control unit, which receives and evaluates sensor data and therefrom determines the current temperature of the at least one vehicle aggregate and/or the vehicle passenger compartment. Additionally, the processing- and control unit can receive and evaluate sensor data to determine the current vehicle speed. Depending on the determined data, the processing- and control unit can activate the power unit and can open or close the passage openings.

According to another advantageous feature of the invention, the base body can include first elements of a snap-lock connection that interact with two body-sided elements of the snap-lock connection and fix the base body on the vehicle front. Advantageously, the base body can simply be mounted by the snap-lock connection, for instance, to a bumper.

According to another advantageous feature of the invention in the first position the first adjustment element and the second adjustment element can be arranged at the vehicle front while generating a low drag. Advantageously, the drag can be kept as low as possible in the first position due to the closed flat outer surface of the vehicle.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic perspective view of an exemplary embodiment of a device according to the invention for adjusting an air flow according to the invention in a first position;

FIG. 2 shows a schematic perspective view of a device for adjusting the air flow of FIG. 1 in a second position;

FIG. 3 shows a schematic perspective view of a device for adjusting the air flow of FIGS. 1 and 2 in a third position;

FIG. 4 shows a schematic perspective view of a device for adjusting the air flow of FIGS. 1 to 3 in the first position from behind; and

FIG. 5 shows a schematic partial sectional view of the device for adjusting the air flow according to FIG. 4 in the first position.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

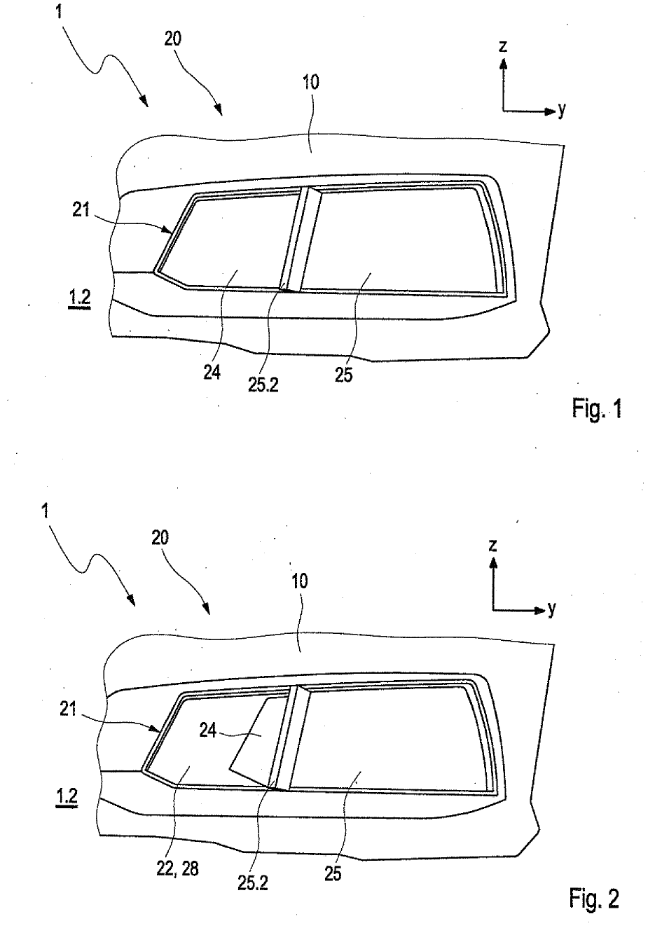

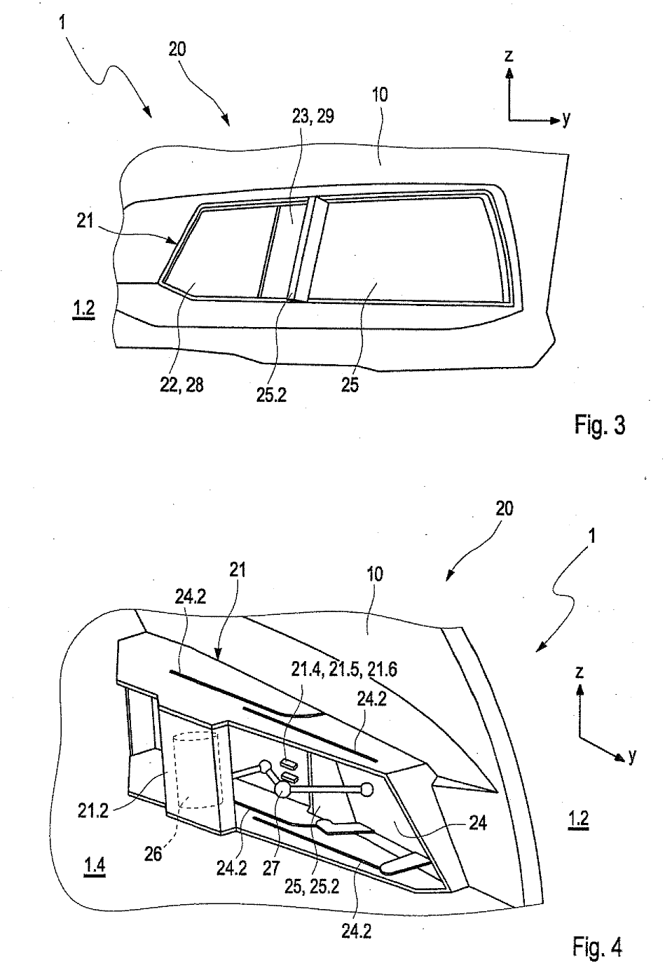

As shown in FIGS. 1 to 5, a device 20 for adjusting an air flow includes a base body 21 and at least two closable or releasable passage openings 22, 23. The passage openings 22, 23 are arranged at a vehicle front section 1 and are each coupled to a corresponding ventilation shaft 28, 29. The device can, for instance, be arranged at a bumper 10, whereat the bumper 10 comprises a front section 1.2 which is directed to an air stream affecting the vehicle and a rear section 1.4 facing the vehicle interior.

According to the invention, a first adjustment element 24 is configured as linearly movable flap 24, which in a first position closes at least two passage openings 22, 23, in a second position releases a first passage opening 22 and closes a second passage opening 23 and in a third position releases both passage openings 22, 23.

As further shown in FIGS. 1 to 5, the base body 21 has recesses, which form the passage openings 22, 23, The passage openings 22, 23 are placed on the corresponding ventilation shafts 28, 29 with corresponding inlet openings. Hereby, the base body 12 forms a frame around the passage openings 22, 23. The at least two passage openings 22, 23 can hereby be either arranged in a side area of the vehicle front 1 or centered on the vehicle front 1.

As further shown in FIGS. 1 to 5, the air flow arising from the vehicle air stream is channeled and directed through the passage openings 22, 23 and is for example conducted to a not further shown heat exchanger. The heat exchanger can be constructed as air-coolant-heat exchanger for a drive aggregate and/or as oil cooler and/or as charge air cooler and/or as air-coolant-heat exchanger for an air conditioner. Thus, the device 20 for adjusting the air flow according to the invention can for example be used for direct or indirect cooling of vehicle aggregates via a corresponding heat exchanger such as for example a drive aggregate and/or a brake unit or a vehicle passenger compartment.

As further shown in FIGS. 1 to 5, the exemplary embodiment of the device 20 for adjusting the air flow according to the invention includes two passage openings 22, 23 which are each coupled to a ventilation shaft 28, 29. To adjust an air flow the two passage openings 22, 23 are released when needed by the first adjustment element 24. A first ventilation shaft 28, which is coupled to the first passage opening 22, can for example be coupled to the heat exchanger of an air conditioner in order to regulate the temperature of the vehicle interior. The second passage opening 23 can be coupled to a second ventilation shaft 29, which, for instance, can be coupled to a heat exchanger such as for example a charge air cooler or an oil cooler, in order to cool drive aggregates and/or to cool brake systems. The device 20 for air flow adjustment according to the invention operates in stages and, if needed, only supplies one ventilation shaft 28 or several ventilation shafts 28, 29 with the cooling air stream. This advantageously optimizes, cooling air influx. Beside the adjusting of the air flow and optimizing the cooling air influx, a drag of the vehicle is also optimized. When the passage openings 28, 29 are closed, the drag is minimal.

In an alternative not shown exemplary embodiment, the device 20 for air flow adjustment according to the invention can include further passage openings 22, 23 and positions of the first adjustment element 24. In a not shown alternative embodiment, the device 20 for air flow adjustment can for example include three passage openings 22, 23. In the first position, the first adjustment element 24 closes all three passage openings 22, 23. In a second position, the first adjustment element 24 releases the first passage opening 22 and closes the second passage opening 23 and a third passage opening. In a third position, the first adjustment element 24 releases the first passage opening 22 and the second passage opening 23 and closes the third passage opening. In a fourth position the first adjustment element 24 releases all passage openings 22, 23. Of course other opening combinations of the three passage openings can be implemented, for example as an alternative the first adjustment element can release the first passage opening in a second position and release the second passage opening while only closing the third passage opening etc.

As further shown in FIGS. 1 to 5, the first adjustment element 24 is supported horizontally movable in transverse direction y of the vehicle and the at least two passage openings 22, 23 are arranged next to each other in transverse direction y of the vehicle. As a result the passage openings 22, 23 can be opened and released with lower drag by lateral displacement of the first adjustment element 24. In an alternative not shown embodiment, the first adjustment element 24 can be supported vertically movable in vertical direction z of the vehicle and the at least two passage openings 22, 23 can be arranged one above the other in vertical z direction of the vehicle. As further shown in FIGS. 1 to 5, a second adjustment element 25 forms a fin 25.2 when the first adjustment element 24 is arranged in the second or third position. In an preferred exemplary embodiment, the fin 25.2 can be formed by folding and/or bending the second adjustment element 25. The fin 25.2 forms an air stream guide on the front area 1.2 facing the active air stream, which can be activated if needed. The fin 25.2 can replace a separate or fixed air baffle, whereby the development of further air friction effects can at least be reduced.

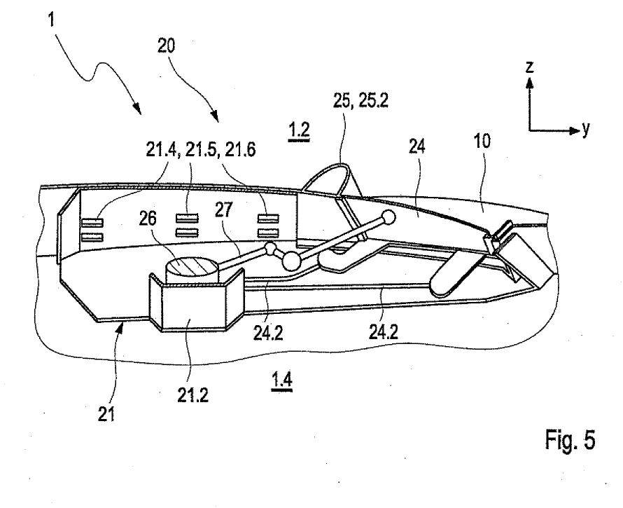

As further shown in FIGS. 4 and 5, the base body 21 includes at least one slotted guide 24.2, which guides the first adjustment element 24. The at least one slotted guide 24.2 extends at least partly behind the second adjustment element 25. In the shown embodiment, the base body 21 includes four slotted guides 24.2, which extend in the rear section 1.4 that faces the vehicle interior. Hereby, two slotted guides 24.2 are inserted into two opposing walls of the base body which. The first adjustment element 24 is guided by corresponding notches within the slotted guides 24.2.

As further shown in FIGS. 4 and 5, the base body 21 has a receptacle 21.2 for a drive 26. The drive 26 is arranged in the rear section 1.4 which faces the vehicle interior. Additionally, the drive 26 is coupled to the first adjustment element 24 and/or to the second adjustment element 25. In the shown embodiment, the drive 26 is designed as an electric motor which is coupled to the first adjustment element 24 by an adjustment element 27. In the shown embodiment, the adjustment element is designed as hinged bracket. Alternatively, the drive 26 can also be coupled to the second adjustment element 25. Alternatively, a second drive can be coupled to the second adjustment element 25. The drive 26 can also be connected to a processing- and control unit, which receives and evaluates sensor data and therefrom determines the current temperature of the at least one vehicle aggregate and/or the passenger compartment. The processing- and control unit is also capable to receive and evaluate sensor data to determine the current vehicle speed. Depending on the determined data, the processing- and control unit can activate the drive 26 and can thereby open and close the passage openings 22, 23.

As further shown in FIGS. 4 and 5, the base body 21 has first elements 21.5 of a latching connection, which interact with second elements 21.6 of the latching connection arranged on the vehicle body and which fix the base body 21 on the vehicle front 1. In the shown exemplary embodiment, the first snap-lock elements 21.5 are configured as receptacles and the second latching elements 21.6 as latching tabs.

As further shown in FIGS. 1 to 5, the first adjustment element 24 and the second adjustment element 25 are rest against the vehicle front 1 in the first position and generate a low drag. The low drag results inter alia from a closed flat outer surface of the vehicle in the first position.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A device for air flow adjustment, comprising:
a base body having at least two closable or releasable passage openings, said passage openings being arranged in a vehicle front area and are each coupled to a respective ventilation shaft; and
a first adjustment element configured as a linearly movable flap, said first adjustment element being movable into a first position in which it closes the at least two passage openings, a second position in which it releases one of the at least two passage openings and closes another one of the at least two passage openings, and a third position in which it closes both of the at least two passage openings.

2. The device of claim 1, wherein the first adjustment element is supported horizontally movable in transverse direction of the vehicle, and wherein the at least two passage openings are arranged next to each other in the transverse direction of the vehicle.

3. The device of claim 1, further comprising a second adjustment element which forms a fin when the first adjustment element is arranged in the second or third position.

4. The device of claim 3, wherein the fin is formable by folding and/or bending of the second adjustment element.

5. The device of claim 1, wherein the base body has at least one slotted guide which guides the first adjustment element.

6. The device of claim 5, wherein at least a part of the at least one slotted guide extends behind the second adjustment element.

7. The device of claim 1, wherein the base body comprises a receptacle for receiving a drive.

8. The device of claim 7, wherein the drive is coupled to the first adjustment element and/or the second adjustment element.

9. The device of claim 1, wherein the base body comprises first latching elements, said first latching elements interacting with second latching elements arranged on the vehicle body, thereby forming a latching connection and fixing the base body to the vehicle front.

10. The device of claim 3, wherein the first adjustment element and the second adjustment element are arranged at the vehicle front in the first position and generate a low drag.
